(19) United States
(12) Patent Application Publication
(10) Pub. No.: US 2025/0143460 A1
(43) Pub. Date: May 8, 2025

(54) LATERAL WALL FOR A DRAWER

(71) Applicant: Julius Blum GmbH, Hoechst (AT)

(72) Inventors: Gerald SPERGER, Hard (AT); Benjamin VON DER WELLEN, Bludenz (AT)

(21) Appl. No.: 19/018,694

(22) Filed: Jan. 13, 2025

Related U.S. Application Data
(63) Continuation of application No. PCT/AT2023/060219, filed on Jul. 6, 2023.

(30) Foreign Application Priority Data
Jul. 21, 2022 (AT) GM 50119/2022

(51) Int. Cl. A47B 88/90; A47B 88/95

(52) U.S. Cl. CPC A47B 88/941; A47B 88/95; A47B 2088/902; A47B 2088/955; A47B 2230/07

(57) ABSTRACT

A lateral wall for a drawer, includes at least one rear wall mounting, by which a rear wall can be held transversely to the drawer lateral wall. The rear wall mounting has at least one clamping device by which the rear wall can be held in a clamped manner. The at least one clamping device has at least one clamping lever which can be moved between a clamping position and a release position.

The present application is a continuation of International Application PCT/AT2023/060219 filed on Jul. 6, 2023. Thus, all of the subject matter of International Application PCT/AT2023/060219 is incorporated herein by reference.

### BACKGROUND OF THE INVENTION

The invention relates to a drawer lateral wall for a drawer and to an arrangement comprising at least one such drawer lateral wall and at least one drawer extraction guide.

From the prior art, lateral walls for a drawer are known which comprise at least one rear wall mounting with which a rear wall can be held transversely to the drawer lateral wall. The disadvantage is that the rear wall mounting can only support rear walls with a relatively large minimum thickness, since the fastening elements of the rear wall mounting require this minimum thickness. This requires increased material expenditure and increased costs. In addition, an additional step using a tool is often required to attach the rear wall.

### SUMMARY OF THE INVENTION

The object of the present invention is to at least partially remedy the disadvantages known from the prior art and to provide a drawer lateral wall that is improved compared to the prior art and an arrangement of at least one drawer lateral wall improved in this way and at least one drawer extraction guide. The drawer lateral wall is characterized in particular by the fact that even thin rear walls can be held on the rear wall mounting and/or the assembly effort of the rear wall on the drawer lateral wall is reduced.

In the case of the drawer lateral wall, it is therefore provided that the rear wall mounting has at least one clamping device by which the rear wall can be held in a clamped manner, wherein the at least one clamping device has at least one clamping lever which is movable between a clamping position and a release position.

The clamping device has several advantages: No fastening elements have to be inserted into the material of the rear wall, so that even thin rear walls can be held in place by the rear wall mounting. Furthermore, rear walls of different thickness can be fastened using the clamping device, whereas the rear wall mountings known from the prior art are often only designed for rear walls with a certain thickness. Finally, the clamping device allows the rear wall to be attached to the rear wall mounting without tools, which reduces the installation effort.

### BRIEF DESCRIPTION OF THE DRAWINGS

Further details and advantages of the invention are explained in more detail below with reference to the drawings, in which:

FIG. 1 shows a drawer in a perspective view from the front,

FIG. 2 shows the drawer without front wall in a perspective view from behind,

FIG. 3 shows an enlarged section of the region of the rear wall mounting, wherein the drawer base and the rear wall are not connected to the drawer lateral wall,

FIGS. 4, 5 show a drawer lateral wall in a perspective view (FIG. 4) and in an exploded view (FIG. 5),

FIGS. 6, 7 show an enlarged section of the region of the front wall mounting, with FIG. 6 showing an unconnected state and FIG. 7 a connected state of the drawer base with the drawer lateral wall,

FIG. 8 shows an enlarged cross-sectional view from the region of the fastening means 13,

FIGS. 9, 10 show a rear wall mounting according to a first exemplary embodiment in a perspective view from behind (FIG. 9) and from the front (FIG. 10),

FIGS. 11-15 show different views of the region of the rear wall mounting during a fastening process of the rear wall, wherein FIGS. 12 and 14 show cross-sectional views and FIGS. 11, 13 and 15 show perspective views from behind,

FIGS. 16, 17 show an enlarged section of the region of the rear wall mounting, wherein the rear wall is attached to the rear wall mounting by means of screws,

FIG. 18 shows an arrangement composed of a drawer lateral wall and a drawer extraction guide in a perspective view,

FIGS. 19-24 show a rear wall mounting according to a second exemplary embodiment, without and with rear wall, respectively, in a perspective view from behind (FIGS. 19, 22), from the front (FIGS. 20, 23) and in a plan view from above (FIGS. 21, 24),

FIGS. 25-29 show a rear wall mounting according to a third exemplary embodiment in a perspective view from behind (FIGS. 25, 28, 29), from the front (FIG. 27) and in a plan view from above (FIG. 26), wherein FIG. 28 shows a connected wooden rear wall in a cut-open view and FIG. 29 shows a connected metal rear wall in a cut-open view,

FIGS. 30, 31 show a rear wall mounting according to a fourth exemplary embodiment in a perspective view from behind, without rear wall (FIG. 30) and with rear wall (FIG. 31),

FIGS. 32-34 show a front wall mounting for connecting a front wall to a drawer lateral wall, wherein FIG. 32 shows a perspective view, FIG. 34 an exploded view and FIG. 33 the adjustment of a connecting element relative to the front wall mounting,

FIGS. 35-37 show another exemplary embodiment of a clamping lever in different views,

FIGS. 38, 39 show an arrangement of a drawer lateral wall, a rear wall and a rear wall mounting according to a further exemplary embodiment and in a cross-sectional view, wherein the clamping lever is arranged in the release position in FIG. 38 and in the clamping position in FIG. 39,

FIGS. 40-42 show an arrangement of a drawer lateral wall, a rear wall mounting and a rear wall according to a further exemplary embodiment, wherein the rear wall assumes different relative positions with respect to the drawer lateral wall, and

FIG. 43 shows a drawer lateral wall with a rear wall mounting according to a further exemplary embodiment.

### DETAILED DESCRIPTION OF THE INVENTION

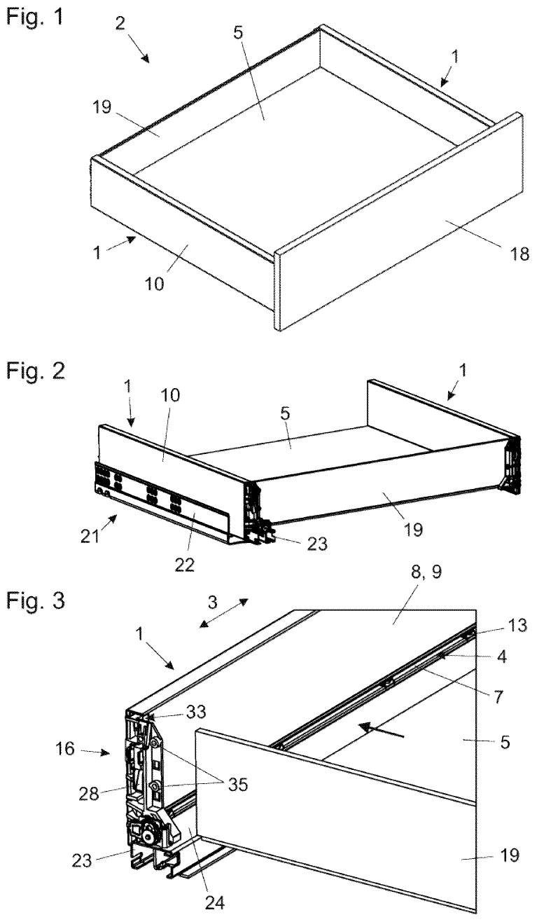

FIG. 1 shows a drawer 2 in a perspective view from the front. FIG. 2 shows the drawer 2 without front wall 18 in a perspective view from behind, FIG. 3 shows an enlarged section of the region of the rear wall mounting, wherein the drawer base and the rear wall are not connected to the drawer lateral wall,

The drawer 2 has two drawer lateral walls 1 arranged parallel and at a distance from one another, a rear wall 19, a front wall 18, and a drawer base 5, preferably wherein the rear wall 19 and the drawer base 5 have substantially the same thickness 26, 27, particularly preferably less than 1 cm. The thickness 26 of the drawer base 5 is shown in FIG. 5, the thickness 27 of the rear wall 19.

In a preferred exemplary embodiment, the rear wall 19 and the drawer base 5 can be fastened to the drawer lateral wall 1 by a common joining movement, particularly preferably by clamping. The common joint movement is indicated by an arrow in FIG. 3.

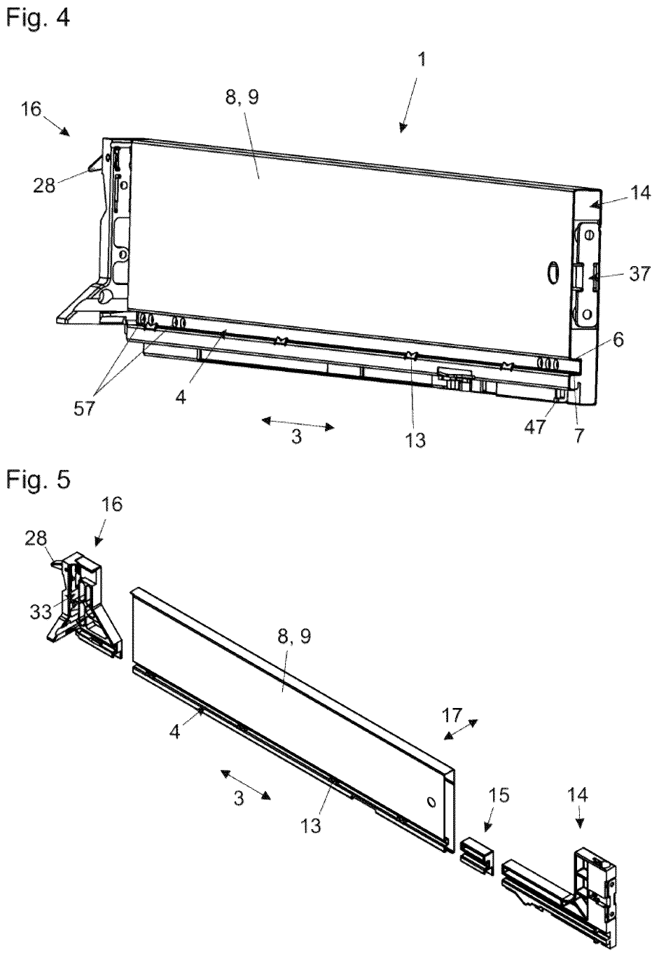

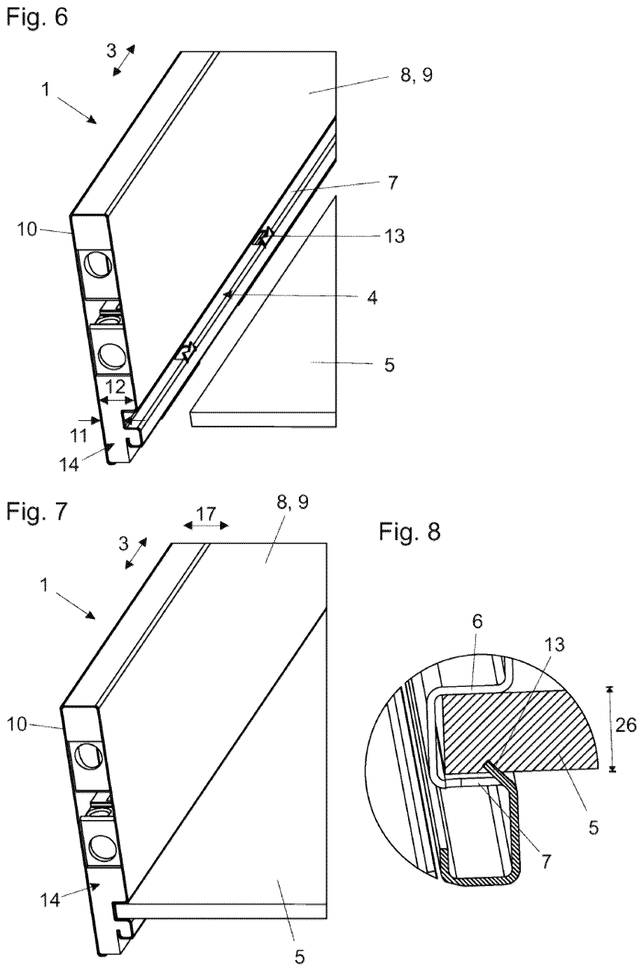

FIGS. 4 and 5 show a drawer lateral wall 1 in a perspective view (FIG. 4) and in an exploded view (FIG. 5), FIGS. 6 and 7 show an enlarged section of the region of the front wall mounting 14, FIG. 6 showing an unconnected state and FIG. 7 showing a connected state of the drawer base 5 with the drawer lateral wall 1. FIG. 8 shows an enlarged cross-sectional view from the region of the fastening means 13,

The drawer lateral wall 1 for a drawer 2 comprises at least one groove 4 extending in a longitudinal direction 3 of the drawer lateral wall 1 for receiving an edge of a drawer base 5, wherein the groove 4 has at least one upper mounting web 6 and a lower mounting web 7 spaced therefrom and running substantially parallel, between which the edge of the drawer base 5 can be arranged. At least one lateral surface 8 of the drawer lateral wall 1 is formed from a one-piece sheet metal piece 9, wherein the groove 4 together with the two mounting webs 6, 7 is formed into the sheet metal piece 9 by bending.

The drawer lateral wall 1 is essentially cuboid-shaped and is essentially rectangular in a cross-sectional plane perpendicular to the longitudinal direction 3 of the drawer lateral wall 1.

Fastening means 13, preferably claws, for fastening, preferably by clamping, the edge of the drawer base 5 are arranged on the groove 4, preferably on the lower mounting web 7 of the groove 4. In the illustrated exemplary embodiment, the fastening means 13 are formed in one piece in the sheet metal piece 9, in particular punched out.

As can be seen in particular from FIG. 8, the fastening means 13 can have barbs which can be driven over when the drawer base 5 is pushed in, but which claw into the material of the drawer base 5 when the drawer base 5 moves in a direction opposite to the insertion direction.

The sheet metal piece 9 can form a hollow profile as in the illustrated exemplary embodiment, preferably with a U-shaped cross-section.

At least one, preferably at least two profile bodies 14, 15, 16, preferably made of plastic, which are spaced apart from one another in the longitudinal direction 3 of the drawer lateral wall 1, are inserted into the hollow profile, which stabilizes the hollow profile at least in one direction 17 transverse to the longitudinal direction 3 of the drawer lateral wall 1, preferably wherein the at least one profile body 14, 15, 16 has a shape adapted to the inner shape of the hollow profile.

The at least one profile body 14, 15, 16 has, at least in the region of the groove 4, the same cross-sectional shape as the sheet metal piece 9.

In the embodiment shown in FIG. 5, at least one profile body 14 is arranged in a front region of the drawer lateral wall 1 and is designed to hold a front wall 18. At least one profile body 16 is arranged in a rear region of the drawer lateral wall 1 and is designed to hold a rear wall 19. At least one profile body 15 is arranged in a central region of the drawer lateral wall 1. The profile body 15 can be omitted for short nominal lengths.

The profile bodies 14, 15 and/or 16 can be connected to the hollow profile via a collar 57.

The drawer lateral wall 1 has an outer surface 10 which is aligned substantially parallel to the lateral surface 8 with the groove 4.

As can be seen in particular from FIG. 6, the groove 4 is recessed into the drawer lateral wall 1 opposite the lateral surface 8. The drawer lateral wall 1 has a reduced thickness 11 in the region of the groove 4, preferably wherein the thickness 11 in the region of the groove 4 is reduced to between one third and one half of the thickness 12 of the drawer lateral wall in a region outside the groove 4.

The drawer lateral wall 1 has a substantially constant thickness 12 in an region outside, preferably above, the groove 4.

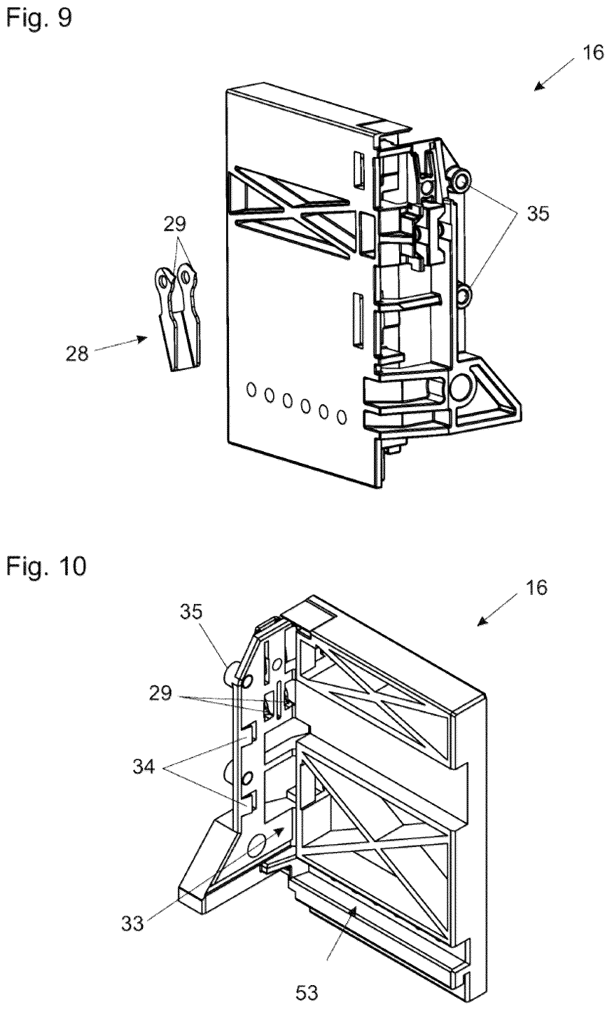

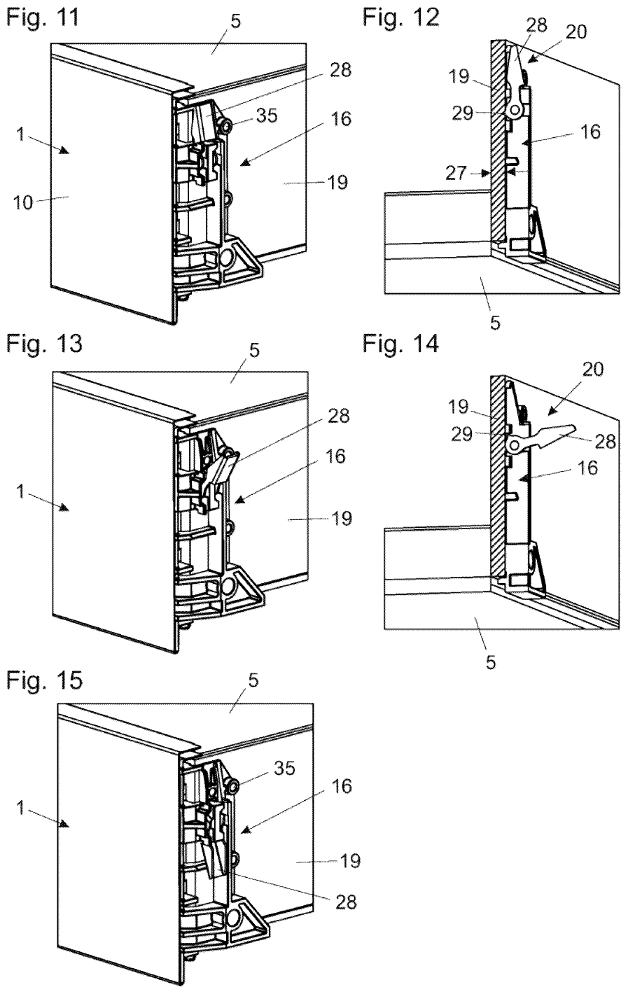

FIGS. 9, 10 show a rear wall mounting according to a first exemplary embodiment in a perspective view from behind (FIG. 9) and from the front (FIG. 10), FIGS. 11-15 show different views of the region of the rear wall mounting during a fastening process of the rear wall, wherein FIGS. 12 and 14 show cross-sectional views and FIGS. 11, 13 and 15 show perspective views from behind,

The drawer lateral wall 1 comprises at least one rear wall mounting 16, with which a rear wall 19 can be held transversely to the drawer lateral wall 1, wherein the rear wall mounting 16 has at least one clamping device 20, with which the rear wall 19 can be held in a clamping manner.

The at least one clamping device 20 can have at least one clamping lever 28 which is movable between a clamping position (cf. FIG. 11) and a release position (cf. FIG. 15), preferably wherein the clamping lever 28, as in the illustrated embodiment, has at least one cutting edge 29 (cf. FIG. 9), which can be sunk into the material of the rear wall 19 during a movement of the clamping lever 28 into the clamping position (cf. FIG. 12).

The at least one rear wall mounting 16 can have at least one mounting groove 33 running transversely to a longitudinal direction 3 of the drawer lateral wall 1, in which the rear wall 19 can be arranged in regions (cf. FIG. 10).

The at least one rear wall mounting 16 can have at least one play compensation device 34, which preferably has at least one resilient tab, with which the rear wall 19 can be urged in the direction of the drawer lateral wall 1.

The rear wall mounting 16 has the same cross-sectional shape as the sheet metal piece 9, at least in the region of the groove 4. In particular, the rear wall mounting 16 comprises a receiving groove 53 in which the groove 4 of the sheet metal piece 9 can be arranged at least in regions.

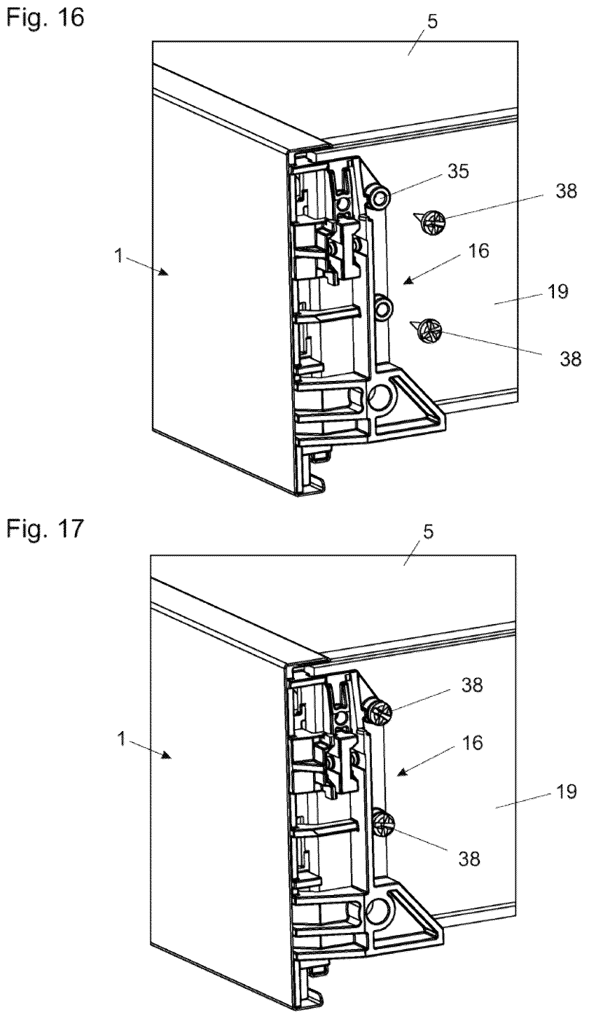

The at least one rear wall mounting 16 can have at least one fastening device 35, via which the rear wall 19 can be fastened in addition to the at least one clamping device 20. FIGS. 16 and 17 show an enlarged section of the region of the rear wall mounting 16, wherein the rear wall 19 is fastened to the rear wall mounting via screws 38.

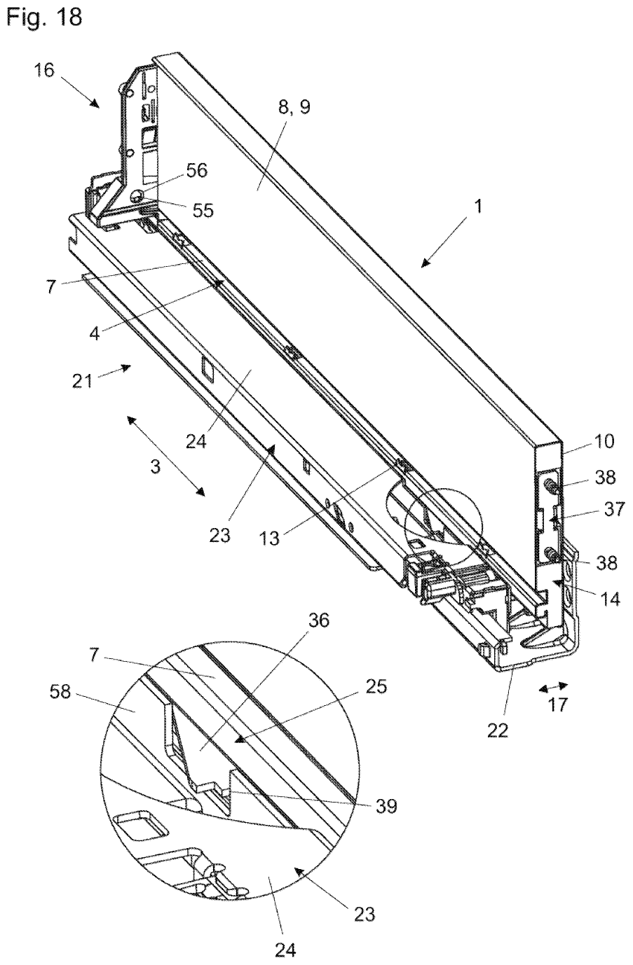

FIG. 18 shows an arrangement composed of a drawer lateral wall 1 and a drawer extraction guide 21 in a perspective view,

The drawer extraction guide 21 has a body rail 22 to be connected to a furniture body and at least one drawer rail 23 which is movable relative thereto. A middle rail can also be arranged between the body rail 22 and the drawer rail 23.

The drawer rail 23 has at least one support web 24 for the drawer base 5, which in a coupled state in which the drawer lateral wall 1 is coupled to the drawer extraction guide 21 is arranged substantially in a plane with the lower mounting web 7 of the groove 4 of the drawer lateral wall 1.

In a coupled state, the drawer lateral wall 1 is arranged at least in part between a fastening web of the body rail 22 and a vertical web 58 of the drawer rail 23 arranged parallel thereto.

At least one coupling device 25 is provided, with which the drawer lateral wall 1 can be coupled, preferably releasably, to the drawer extraction guide 21.

Preferably, the coupling device 25, as in the illustrated exemplary embodiment, has a coupling lever 36 and a coupling contour 39 cooperating therewith, wherein the coupling lever 36 is arranged on the drawer lateral wall 1, preferably on the front wall mounting 14, and the coupling contour 39 is arranged on the drawer rail 23, preferably on a vertical web 58 of the drawer rail 23, or vice versa.

Alternatively or additionally, the drawer lateral wall 1 can be connected to the drawer rail 23 via a hook 55 which can be inserted into an opening 56, preferably with the hook 55 being arranged on the drawer rail 23 and the opening 56 in the rear wall mounting 16.

The front wall mounting 14 can be designed to receive and, preferably detachably, hold a connecting element 37 to be connected to a front wall 18.

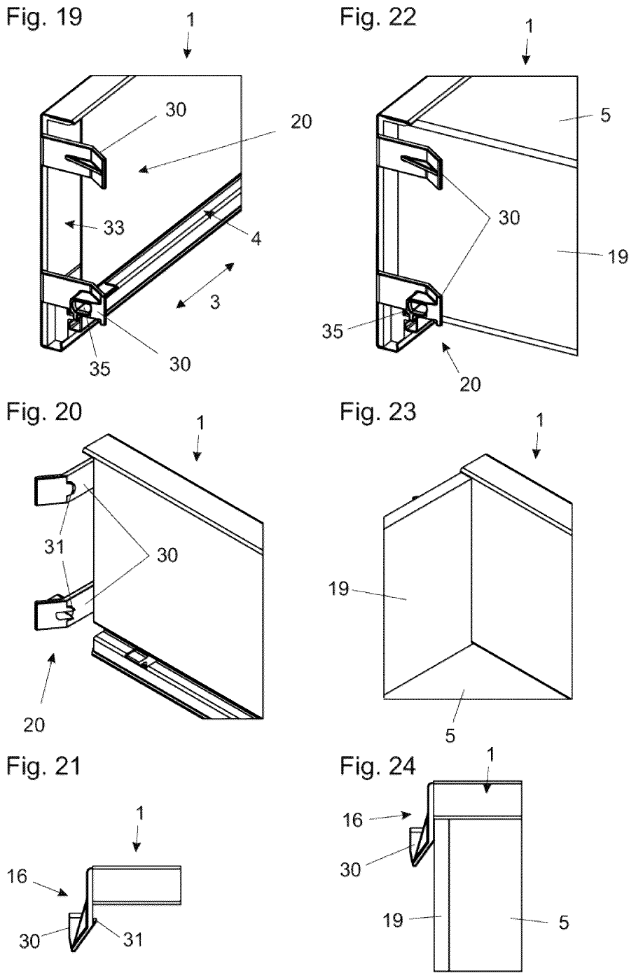

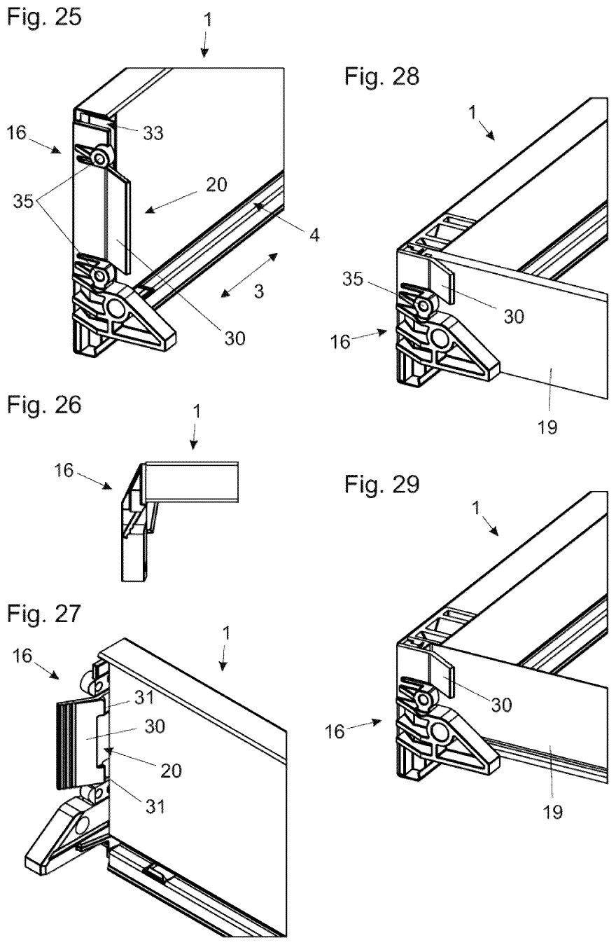

FIGS. 19-24 show a rear wall mounting according to a second exemplary embodiment, without and with rear wall, respectively, in a perspective view from behind (FIGS. 19, 22), from the front (FIGS. 20, 23) and in a plan view from above (FIGS. 21, 24), FIGS. 25-29 show a rear wall mounting 16 according to a third exemplary embodiment in a perspective view from behind (FIGS. 25, 28, 29), from the front (FIG. 27) and in a plan view from above (FIG. 26), wherein FIG. 28 shows a connected wooden rear wall in a cut-open view and FIG. 29 shows a connected metal rear wall in a cut-open view.

In these embodiments, the at least one clamping device 20 has at least one resilient clamping part 30, wherein the clamping part 30 has at least one clamping contour 31 pointing in the direction of the drawer lateral wall 1 and is aligned substantially transversely to the drawer lateral wall 1. When an edge of the rear wall 19 is pushed in, the clamping part 30 is deflected against a spring action and, in the pushed-in state of the rear wall 19, presses the clamping contour 31 onto the rear wall 19. The clamping contour 31 can have at least one barb.

The clamping device 20 can be designed to clamp both a substantially cuboid-shaped rear wall 19 made of a wood material (cf. FIG. 28) and a profiled rear wall 19 made of a metallic material (cf. FIG. 29).

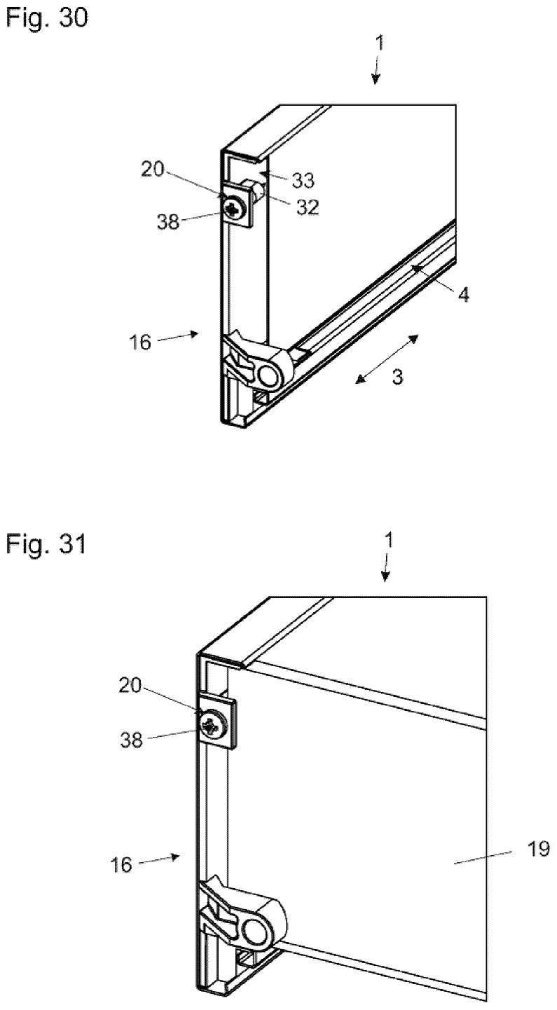

FIGS. 30, 31 show a rear wall mounting 16 according to a fourth exemplary embodiment in a perspective view from behind, without rear wall (FIG. 30) and with rear wall (FIG. 31).

In this embodiment, the at least one clamping device 20 comprises at least one rotatably mounted clamping element 32, wherein the rear wall 19 can be subjected to a clamping force by the clamping element 32 in a direction transverse to a longitudinal direction 3 of the drawer lateral wall 1. The clamping element 32 can be supported on an inner side of a hollow profile of the drawer lateral wall 1 and can be placed on a front side of the rear wall 19. The clamping element 32 has an outer contour deviating from a rotationally symmetrical cylinder shape, which can displace an end face of the rear wall 19 during rotation and thus exert a clamping force on the rear wall 19 in a direction transverse to a longitudinal direction 3 of the drawer lateral wall 1.

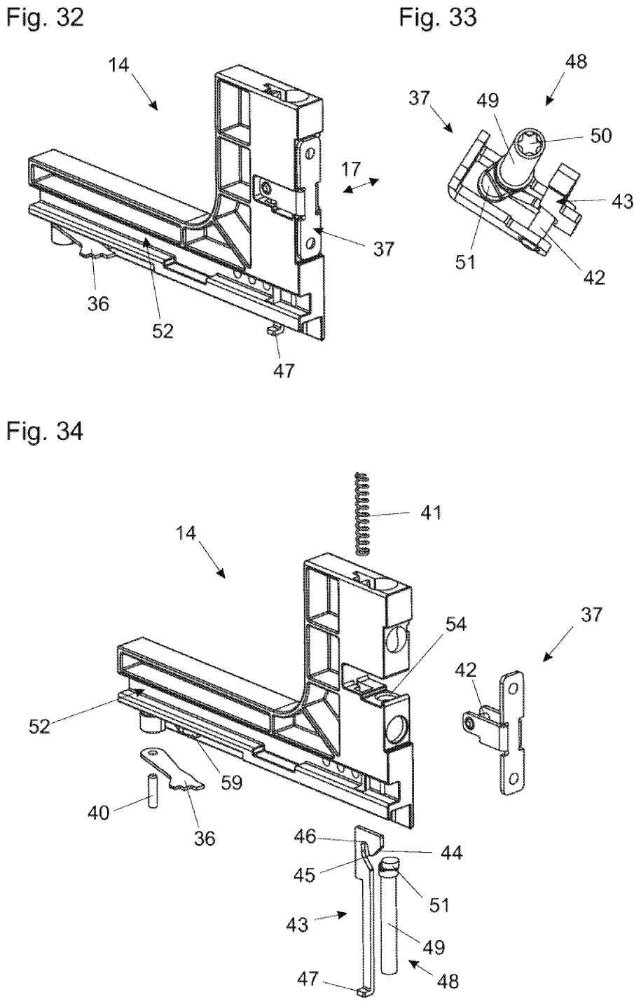

FIGS. 32-34 show a front wall mounting 14 for connecting a front wall 18 to a drawer lateral wall 1, wherein FIG. 32 shows a perspective view, FIG. 34 an exploded view and FIG. 33 the adjustment of a connecting element 37 relative to the front wall mounting 14.

The front wall mounting 14 has at least one fastening device, via which the connecting element 37 is fastened, preferably releasably, to and/or in the front wall mounting 14.

For this purpose, the fastening device can have at least one spring-loaded and displaceably mounted fastening latch 43, as in the case shown. A spring 41 is provided which applies a force to the fastening latch 43 in the direction of a fastening position.

To connect the connecting element 37 to the fastening latch 43, a bolt 42 of the connecting element 37 comes into contact with an inclined surface 44 of the fastening latch 43, wherein the fastening latch 43 is urged against the force of the spring 41 from the fastening position into a release position. The bolt 42 overcomes a nose 45 and, under the influence of the spring force, enters a recess 46. The fastening latch 43 is moved back into the fastening position.

For unlocking, the fastening latch 43 has an actuator 47 on an underside.

At least one adjustment device 48 is provided, with which the connecting element 37 can be adjusted at least in one direction 17 transverse to a longitudinal direction 3 of the drawer lateral wall 1, relative to the drawer lateral wall 1.

The adjustment device 48 can, as in the case shown, have a rod 49 which comprises an actuating element 50 at a first end and an eccentric 51 at a second end opposite the first end. The rod 49 can be mounted in a corresponding recess 54 of a base body of the connecting element 37. When the adjustment device 48 is actuated, the eccentric 51, which is in engagement with the connecting element 37 or can be brought into engagement with it, displaces the connecting element 37 in a direction 17 transverse to a longitudinal direction 3 of the drawer lateral wall 1, relative to the drawer lateral wall 1.

The coupling lever 36 of the coupling device 25 for the releasable coupling of the drawer lateral wall 1 with the drawer extraction guide 21 is mounted on the connecting element 37 so as to be rotatable about a rotation axis 40. A spring element 59 is provided which applies a force to the coupling lever 36 in the direction of a coupling position.

The front wall mounting 14 has the same cross-sectional shape as the sheet metal piece 9, at least in the region of the groove 4. In particular, the front wall mounting 14 comprises a receiving groove 52 in which the groove 4 of the sheet metal piece 9 can be arranged at least in regions.

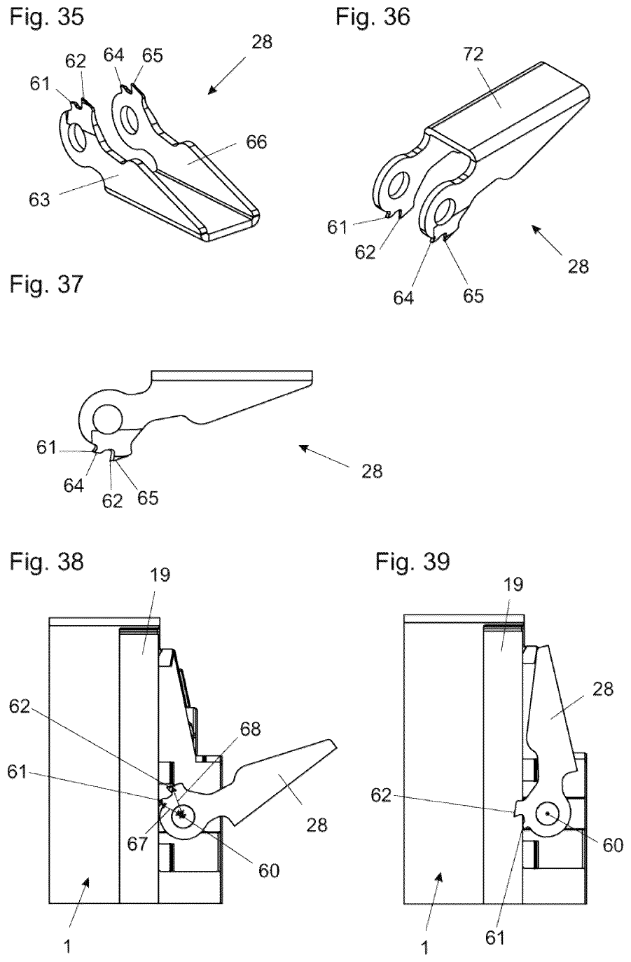

FIGS. 35 to 37 show a further embodiment of a clamping lever 28 in different views.

According to this embodiment, the clamping lever 28 has more than one cutting edge 29, wherein a first cutting edge 61, 62 is arranged on a first web 63 of the clamping lever 28 and a second cutting edge 64, 65 is arranged on a second web 66 of the clamping lever 28 spaced apart from the first web 63.

The two webs 63 and 66 can be connected to each other via a cross web 72. Overall, this results in a cross-section that is essentially U-shaped.

As can be seen from FIG. 37, the cutting edges 61, 62 have an angular offset with respect to the cutting edges 64, 65 when viewed in a pivoting direction of the clamping lever 28. As a result, the increase in force when moving the clamping lever 28 into the clamping position can be reduced, since in this way the cutting edges 61 and 64 and the cutting edges 62 and 65 come into engagement with the material of the rear wall 19 with a slight time offset.

FIGS. 38 and 39 show an arrangement of a drawer lateral wall 1, a rear wall 19 and a rear wall mounting in a cross-sectional view, wherein the clamping lever 28 is arranged in the release position in FIG. 38 and in the clamping position in FIG. 39.

In this and the previously described embodiments in which a clamping lever was provided, the clamping lever 28 is mounted on the rear wall mounting 16 so as to be pivotable about a pivot axis 60, wherein the pivot axis 60 runs essentially normal to the drawer lateral wall 1 and, in a state of use of the drawer lateral wall 1, essentially horizontally.

At least two cutting edges 61, 62 are arranged on the clamping lever 28 in a common plane, the cutting edges 61, 62 having different maximum radial extensions 67, 68 relative to the pivot axis 60 of the clamping lever 28, the cutting edges 61, 62 being arranged on the clamping lever 28 in such a way that, during a movement of the clamping lever 28 into the clamping position, first a cutting edge 61 with a smaller maximum radial extension 67 and then a cutting edge 62 with a larger maximum radial extension 68 can be sunk into the material of the rear wall 19. This measure also serves to reduce the increase in force when moving the clamping lever 28 into the clamping position.

The cutting edges 64 and 65 are designed analogously to the cutting edges 61 and 62.

Overall, the clamping lever 28 in the embodiments of FIGS. 35 to 39 has four cutting edges 61, 62, 64 and 65.

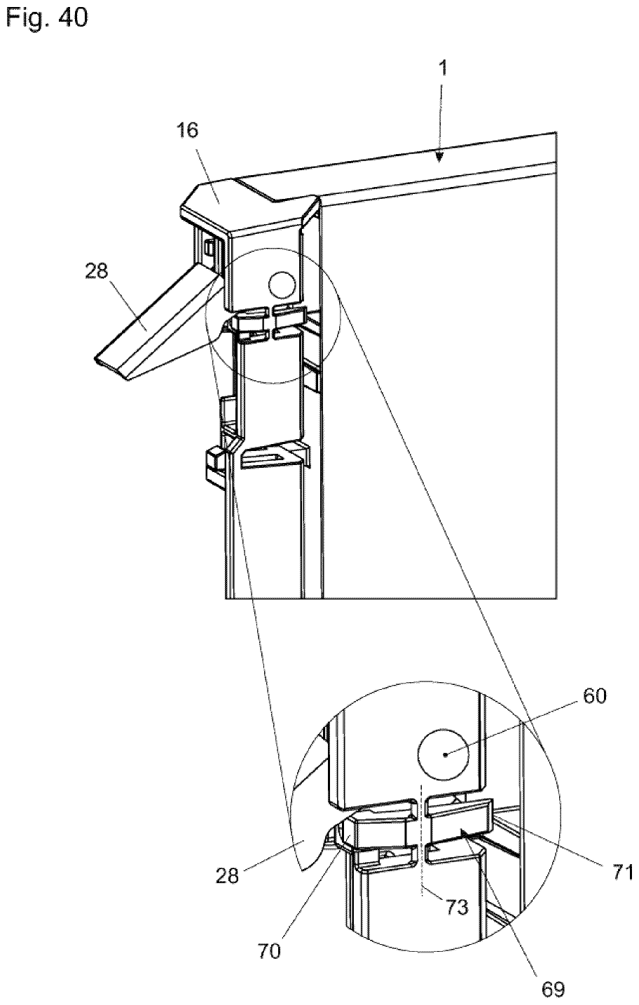

FIGS. 40-42 show an arrangement of a drawer lateral wall 1, a rear wall mounting 16 and a rear wall 19 according to a further exemplary embodiment, wherein the rear wall 19 assumes different relative positions with respect to the drawer lateral wall 1.

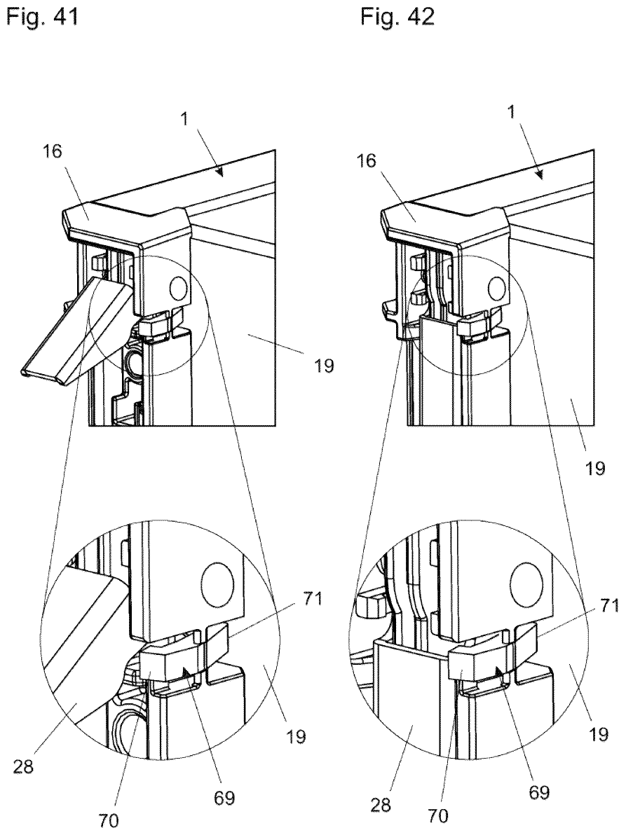

When mounting the rear wall 19, it may happen that the clamping lever 28 is already in the clamping position. If one now attempts to push the rear wall 19 into the rear wall mounting 16, there is a risk that the clamping lever 28 and/or the rear wall 19 will be damaged and proper assembly will no longer be possible. In order to prevent this, at least one mounting device 69 can be provided which holds the clamping lever 28 in a first position (cf. FIG. 40) in an assembly position and in a second position releases the movement of the clamping lever 28 into the clamping position (cf. FIGS. 41 and 42).

It is advisable that the mounting device 69 is arranged on the rear wall mounting 16 in such a way that the clamping lever 28 can be moved from the first to the second position by inserting the rear wall 19 into the rear wall mounting 16, and/or in that the mounting device 69 is designed as a rotatably mounted latch which has a first end 70 for holding the clamping lever 28 in the assembly position and/or a second end 71 for contacting the rear wall 19.

The latch can be arranged on the rear wall mounting so that it can tilt about the tilt axis 73.

Preferably, the mounting device 69 is formed integrally on the rear wall mounting.

The mounting device 69 prevents the clamping lever 28 from being pivoted downwards as long as the rear wall 19 is not mounted. By retracting the rear wall 19 sideways, the latch is rotated by approximately 20 degrees, freeing the pivoting path of the clamping lever 28 (see FIG. 41) and this can be pivoted into the clamping position (see FIG. 42).

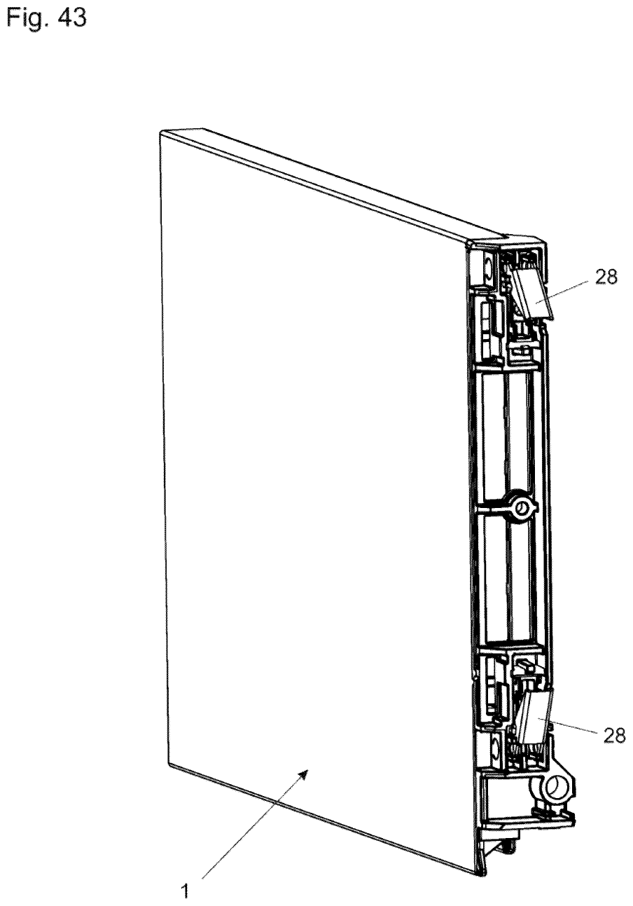

FIG. 43 shows a drawer lateral wall 1 with a rear wall mounting 16 according to a further exemplary embodiment. The at least one clamping device 20 has at least two clamping levers 28 spaced apart from one another in a vertical direction, preferably wherein the clamping levers 28 are arranged substantially mirror-symmetrically as in the case shown. However, the mirror-symmetrical arrangement is not mandatory.

The provision of at least two clamping levers 28 is particularly advantageous in the case of high drawer lateral walls 1 in order to keep the rear wall 19 stable.

1. A drawer lateral wall for a drawer, comprising:
at least one rear wall mounting with which a rear wall can be held transversely to the drawer lateral wall, the rear wall mounting having at least one clamping device by which the rear wall can be held in a clamping manner,
wherein the at least one clamping device has at least one clamping lever movable between a clamping position and a release position, the at least one clamping lever being mounted on the at least one rear wall mounting so as to be pivotable about a pivot axis, and the pivot axis running essentially normal to the drawer lateral wall.

2. The drawer lateral wall according to claim 1, wherein the clamping lever has at least one cutting edge which can be sunk into the material of the rear wall during a movement of the clamping lever into the clamping position.

3. The drawer lateral wall according to claim 1, wherein the at least one rear wall mounting has at least one mounting groove running transversely to a longitudinal direction of the drawer lateral wall, in which the rear wall can be arranged in regions.

4. The drawer lateral wall according to claim 1, wherein the at least one rear wall mounting comprises at least one play compensation device, which preferably has at least one resilient tab, with which the rear wall can be urged in the direction of the drawer lateral wall.

5. The drawer lateral wall according to claim 1, wherein the at least one rear wall mounting has at least one fastening device via which the rear wall can be fastened in addition to the at least one clamping device.

6. The drawer lateral wall according to claim 1, wherein the drawer lateral wall comprises at least one groove running in a longitudinal direction of the drawer lateral wall for receiving an edge of a drawer base, the groove has at least one upper mounting web and a lower mounting web spaced therefrom and running essentially parallel, between which the edge of the drawer base can be arranged, at least one lateral surface of the drawer lateral wall is formed from a one-piece sheet metal piece, and the groove together with the two mounting webs is formed into the sheet metal piece by bending.

7. The drawer lateral wall according to claim 6, wherein fastening means, preferably claws, for fastening the edge of the drawer base, preferably in a clamping manner, are arranged on the groove, preferably on the lower mounting web of the groove, preferably wherein the fastening means are formed in one piece in the sheet metal piece, in particular punched out.

8. The drawer lateral wall according to claim 1, wherein the pivot axis runs essentially horizontally in a state of use of the drawer lateral wall.

9. The drawer lateral wall according to claim 2, wherein the at least one clamping lever has more than one cutting edge, preferably wherein:
a first cutting edge is arranged on a first web of the clamping lever and a second cutting edge is arranged on a second web of the clamping lever spaced apart from the first web, preferably, wherein the two cutting edges have an angular offset when viewed in a pivoting direction of the clamping lever, and/or
at least two cutting edges are arranged on the clamping lever in a common plane, the cutting edges having different maximum radial extensions relative to a pivot axis of the clamping lever, wherein the cutting edges are arranged on the clamping lever in such a way that in the course of a movement of the clamping lever into the clamping position, first a cutting edge with a smaller maximum radial extension and then a cutting edge with a larger maximum radial extension can be sunk into the material of the rear wall.

10. The drawer lateral wall according to claim 1, wherein at least one mounting device is provided which holds the at least one clamping lever in a first position in an assembly position and in a second position releases the movement of the at least one clamping lever into the clamping position.

11. The drawer lateral wall according to claim 10, wherein the at least one mounting device is arranged on the rear wall mounting in such a way that the clamping lever can be transferred from the first into the second position by inserting the rear wall into the rear wall mounting, and/or wherein the at least one mounting device is designed as a rotatably mounted latch, which has a first end for holding the clamping lever in the assembly position and/or a second end for contacting the rear wall.

12. The drawer lateral wall according to claim 1, wherein the at least one clamping device has at least two clamping levers spaced apart from one another, preferably in a vertical direction, preferably wherein the clamping levers are arranged substantially mirror-symmetrically.

13. An arrangement comprising:
the drawer lateral wall according to claim 1, and
at least one drawer extraction guide, which has a body rail to be connected to a furniture body and at least one drawer rail displaceable relative thereto.

14. The arrangement according to claim 13, wherein at least one coupling device is provided, with which the drawer lateral wall can be coupled, preferably releasably, to the drawer extraction guide.

15. The arrangement according to claim 13, wherein the arrangement has a rear wall, a front wall, and/or a drawer base, preferably wherein a rear wall and a drawer base are provided which have substantially the same thickness, particularly preferably of less than 1 cm, and/or wherein the rear wall and the drawer base can be fastened to the drawer lateral wall by a common joining movement, particularly preferably by clamping.
